(19) United States
(12) Patent Application Publication
(10) Pub. No.: US 2006/0283288 A1
(43) Pub. Date: Dec. 21, 2006

(54) Insert for bicycle component and bicycle component incorporating such an insert

(75) Inventor: Mauri Feltrin, Nanto (Vicenza) (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: Campagnolo S.r.l., Vicenza (IT)

(21) Appl. No.: 11/454,442

(22) Filed: Jun. 15, 2006

(30) Foreign Application Priority Data
Jun. 17, 2005 (EP) 05425436.2

(51) Int. Cl. G05G 1/14

(52) U.S. Cl. 74/594.1

(57) ABSTRACT

An insert for a bicycle component has a body with an outer surface for the coupling with the bicycle component. The outer surface has at least one first element that provides a first response to an attempt of relative rotation movement between the bicycle component and the body of the insert and at least one second element that provides a contrasting response to the attempt of relative rotation movement. For example, the elements that provide at least contrasting responses can have two opposite threadings that extend on the outer surface of the body in two opposite halves thereof. Advantageously, such opposite threadings prevent, during travel, any possibility of mutual sliding between body of the insert and body of the bicycle component that incorporates the insert, thus avoiding deterioration of the insert-bicycle component coupling.

### FIELD OF INVENTION

The present invention relates to an insert for a bicycle component. More specifically, the invention relates to an insert for a bicycle pedal crank. The invention also relates to a bicycle component, preferably a pedal crank, incorporating such an insert.

### BACKGROUND

Different types of pedal cranks with different shapes, materials and manufacturing processes are known, aimed at achieving the goal of reducing weight and at the same time ensuring the desired characteristics of mechanical resistance and reliability of the pedal crank and/or of the coupling between pedal crank and axle of the bottom bracket and/or of the pedal. Research towards solutions suitable for satisfying the goal of lightness has led to the manufacture of pedal cranks made from composite material.

However, due to the high stresses to which the pedal crank is subjected in use, like the torsion stresses due to the thrusting action of the cyclist during pedaling, it is typically foreseen to insert, into the body of such pedal cranks, reinforcement elements (inserts) that act as an interface between the body of the pedal crank and the elements interacting therewith, like the axle of the bottom bracket, the axle of the pedal and, in the case of the right pedal crank, the toothed wheels.

A composite material pedal crank that incorporates reinforcement elements can be obtained by molding a thermosetting composite material inside a mold in which inserts of metallic material are arranged. Such inserts have a tubular body with a cylindrical outer surface and, centrally, a through hole for connection to the axle of the bottom bracket and/or of the pedal.

During the molding step, the composite material is heated to its plastic state, and covers the inserts, surrounding the insert's outer surface, in contrast with the regions in which the inserts are fixed to suitable support and removal elements from the mold, both of which are not surrounded. The material so arranged inside the mold is pressed and heated until it is reticulated. When reticulation is completed, the pedal crank is removed from the mold using the removal elements and left to cool at room temperature. In the final configuration, the inserts are substantially incorporated in the material with which the pedal crank body is made.

A drawback associated with the solution described in the aforementioned process is that, due to the high torsion stresses to which the pedal crank is subjected during travel, a mutual sliding between insert and pedal crank both in rotation and in translation can occur. This implies a deterioration of the insert-pedal crank coupling, actually preventing the use of the pedal crank.

A second example of a composite pedal crank that incorporates a metallic insert has, on its outer surface, a series of shaped discs that are spaced apart and incorporated in the composite material with which the pedal crank body is made. Such discs allow the contact surface between insert and composite material of the pedal crank to be increased.

A drawback associated with the solution described in the aforementioned composite pedal crank is that, since the outer surface of the insert is mainly cylindrical in shape, the high torsion stresses to which the pedal crank is subjected during travel can cause a relative rotation sliding between insert and pedal crank. This can deteriorate the insert-pedal crank coupling, actually preventing the use of the pedal crank.

Other examples of composite pedal cranks in composite material that incorporate metallic inserts use one of two different types of inserts.

A first type of insert has the outer surface partially or totally provided with a left-hand threading. In the pedal crank a hole is formed provided with a corresponding internal threading. The insert-pedal crank coupling therefore takes place by screwing the insert into the pre-formed hole of the pedal crank. The left-hand threadings ensure that, during pedaling, the insert is subjected to a screwing stress.

Such a solution has the drawback that, when the cyclist stands up on the pedals, with the pedals arranged along a direction not perpendicular to the ground, the insert of the pedal crank arranged towards the rear wheel is subjected to an unscrewing action. In the case of particularly high stresses, for example when the cyclist stands up on the pedals to go over a hole in the ground, a relative roto-translation sliding between insert and pedal crank can occur. This can deteriorate the insert-pedal crank coupling, actually preventing the use of the pedal crank.

A second type of insert has the outer surface suitably shaped, in particular a hexagonal prismatic outer surface or an outer surface equipped with ribs that extend longitudinally on the body of the insert. A hole of a shape matching that of the outer surface of the insert is formed in the pedal crank.

Such a solution has the drawback that the high torsion stresses to which the pedal crank is subjected during travel can determine a mutual translation sliding between insert and pedal crank. This can deteriorate the insert-pedal crank coupling, also in this case actually preventing the use of the pedal crank.

The Applicant has therefore noted a drawback common to all pedal cranks of the prior art described above; such a drawback exists in the possibility that, due to the high torsion stresses to which the pedal crank is subjected during travel, mutual movement between insert and pedal crank occurs, with consequent deterioration of the insert-pedal crank coupling.

The technical problem at the basis of the present invention is that of making an insert for a bicycle component provided with means adapted to discourage movement between the insert and bicycle component with which the insert is associated, thus increasing the reliability of the insert-bicycle component coupling.

### SUMMARY

The present invention therefore relates, in a first aspect thereof, to an insert for a bicycle component, comprising a body provided with an outer surface for the coupling with a bicycle component, wherein said outer surface comprises at least one first element adapted to provide a first response to an attempt of relative rotational movement between said bicycle component and said body, wherein said outer surface comprises at least one second element adapted to provide a contrasting response to said attempt of relative rotational movement between said bicycle component and said body.

### BRIEF DESCRIPTION OF THE DRAWING(S)

Further characteristics and advantages of the present invention shall become clearer from the following detailed description of some preferred embodiments, made with reference to the attached drawings. In such drawings:

FIG. 1 is a schematic front view of a specific embodiment of a bicycle component, in particular a spoked right pedal crank, which incorporates the insert of the present invention;

FIG. 2 is a sectional view along the plane indicated by the lines I-I of the bicycle component of FIG. 1;

FIG. 3 is a schematic perspective view of a first embodiment of the insert of the present invention;

FIG. 4 is a schematic side view of the insert of FIG. 3;

FIG. 5 is a sectional view of the insert of FIG. 3 along the plane indicated by the lines A-A in FIG. 4;

FIG. 6 is a schematic perspective view of a second embodiment of the insert of the present invention;

FIG. 7 is a schematic side view of the insert of FIG. 6;

FIG. 8 is a sectional view of the insert of FIG. 6 along the plane indicated by the lines A-A in FIG. 7;

FIG. 9 is a schematic side view of a third embodiment of the insert of the present invention;

FIG. 10 is a schematic side view of a fourth embodiment of the insert of the present invention;

FIG. 10a is a schematic side view of an alternative of the fourth embodiment of the insert of the present invention;

FIG. 11 is a schematic side view of a fifth embodiment of the insert of the present invention; and

FIG. 12 is a schematic side view of a sixth embodiment of the insert of the present invention.

### DETAILED DESCRIPTION OF THE PREFERRED EMBODIMENT(S)

Introduction

Throughout the present description and in the subsequent claims, the term “insert” is used to indicate an element intended to be incorporated in a bicycle component and to act as an interface in the coupling between said bicycle component and another bicycle component. Such an element constitutes in particular a reinforcement element in the coupling between the aforementioned bicycle components.

For example, in the case in which the bicycle component that incorporates the insert is a pedal crank, the insert can be a connection bush to the axle of the bottom bracket and/or to the axle of the pedal and/or to the toothed wheels to equip the crankset of the bicycle.

Throughout the present description and in the subsequent claims, explicit reference shall often be made to a specific embodiment of the bicycle component in which the bicycle component is a pedal crank and the insert is a connection bush to the axle of the bottom bracket of the bicycle. However, it should be understood that the bicycle component could be different, for example the seat post, in which case the insert would be the connection part of the head of the seat post to the seat post tube, or the seat clamp of the seat post, in which case the insert would be the attachment interface of the seat clamp to the seat.

Moreover, although reference shall be made to perforated inserts for receiving an intermediate connection element such as a screw or an axle, it should be understood that the connection element can include the insert, for example directly incorporating into the pedal crank, the pedal's or the bottom bracket's axle.

Advantageously, the inclusion of elements on the outer surface of the insert of the present invention adapted to provide a contrasting response to an attempt of relative rotation movement between insert and bicycle component actually prevents any possibility of mutual sliding between insert and pedal crank component when the insert is incorporated into the material that constitutes the body of the bicycle component. The insert-bicycle component coupling is therefore more reliable than those described above with reference to the prior art.

In accordance with the present invention, by suitably orientating the aforementioned elements on the outer surface of the insert it is possible to prevent any mutual movement between insert and pedal crank component, i.e. translation, rotation and/or roto-translation movements.

The aforementioned first and second elements can be made in the form of grooves formed on the outer surface of the insert or in the form of ribs, fins or threads that project from the outer surface of the insert. In general, it is possible to achieve the desired result through at least one pair of elements having various shapes, provided that such a pair of elements is oriented on the outer surface of the insert, so as to be capable of providing contrasting responses to the same attempt of relative rotation movement between insert and bicycle component.

Preferably, the body of the insert of the present invention is substantially tubular and extends along a longitudinal axis. More preferably, the insert of the present invention is used as an interface element in the coupling between pedal crank and axle of the bottom bracket of the bicycle, or between pedal crank and axle of the pedal or, in the case of the right pedal crank, between pedal crank and toothed wheels of the crankset of the bicycle.

Preferably, said at least one first element extends on said outer surface for at least one first length inclined, with respect to a generatrix of said body parallel to said longitudinal axis, by at least one first angle of between 0 and 90° and said at least one second element extends on said outer surface for at least one second length inclined, with respect to said generatrix, by at least one second angle of between 90° and 180°.

Advantageously, an orientation of the aforementioned first and second elements as described above allows opposite reaction force components to be obtained at the first and second elements, respectively, in response to a given stress on the insert and/or on the bicycle component with which the insert is associated. Such opposite components are effective in preventing any possible mutual movement between insert and bicycle component that should occur as a consequence of the application of the aforementioned stress.

More preferably, said first angle and said second angle are supplementary angles. In such a case, advantageously, the reaction force components are exactly equal and opposite, thus making a substantial dynamic equilibrium at the interface between insert and bicycle component and actually preventing any possible mutual movement that should occur as a consequence of the application of said stress.

Preferably, said at least one first length is at least partially defined along at least one first spiral path that extends on said outer surface in a first direction of rotation and said at least one second length is at least partially defined along at least one second spiral path that extends on said outer surface in a second direction of rotation opposite said first direction of rotation.

More preferably, said at least one first spiral path is a first helical path that extends on said outer surface with a first pitch in said first direction of rotation and said at least one second spiral path is a second helical path that extends on said outer surface with a second pitch in said second direction of rotation opposite said first direction of rotation.

More preferably, said second pitch is equal to said first pitch.

In a particularly preferred embodiment of the insert of the present invention, said at least one first element comprises at least one first threading that extends on said outer surface along said at least one first helical path and said at least one second element comprises at least one second threading that extends on said outer surface along said at least one second helical path.

Preferably, said at least one first threading consists of two distinct threads that extend on said outer surface according to said at least one first helical path. Even more preferably, said at least one second threading also consists of two distinct threads that extend on said outer surface according to said at least one second helical path.

Advantageously, in such a way two opposite threadings, each having two threads, are made on the outer surface of the insert. Such threadings are particularly effective in preventing any possible mutual movement between insert and bicycle component and in increasing the grasping surface between insert and material that constitutes the body of the bicycle component.

Preferably, the two threads of the first threading and, more preferably, also the two threads of the second threading are out of phase by 180° in a cross section of said body.

Alternatively, said at least one first threading consists of a single thread. In such a case, preferably, said at least one second threading also consists of a single thread.

In such a case, two opposite threadings, each having a single thread, are made on the outer surface of the insert.

In accordance with an alternative embodiment of the insert of the present invention, said at least one first element comprises at least one first groove that extends on said outer surface along at least part of said at least one first helical path and said at least one second element comprises at least one second groove that extends on said outer surface along at least part of said at least one second helical path.

In accordance with a further alternative embodiment of the insert of the present invention, said at least one first element comprises at least one first rib that extends on said outer surface along at least part of said at least one first helical path and said at least one second element comprises at least one second rib that extends on said outer surface along at least part of said at least one second helical path.

Preferably, in all of the embodiments described above, said outer surface comprises a first portion that extends at least in part on a first half of said body along said longitudinal axis and a second portion that extends at least in part on the other half of said body along said longitudinal axis and in which said at least one first helical path extends in said first portion and said at least one second helical path extends in said second portion.

Preferably, the insert of the present invention comprises at least one fin projecting cantilevered from said outer surface. Advantageously, such a fin allows the grasping surface between the insert and the material that constitutes the body of the bicycle component to be increased.

Even more preferably, said second portion entirely extends on said first half of said body and said first portion extends on the other half of said body for a length less than the length of said other half of the body, and in which between said first and second portions an intermediate portion is defined that comprises said at least one fin.

Preferably, said at least one fin extends annularly around said body.

In accordance with a further alternative embodiment thereof, the insert of the present invention comprises a plurality of first grooves that extend along said first helical path and a plurality of second grooves that extend along said second helical path, said first and second grooves alternating along said longitudinal axis. Advantageously, the opposite grooves on the outer surface of the insert ensure that, when the grooves are filled by the material that constitutes the body of the bicycle component, there is no mutual sliding between insert and bicycle component that incorporates the insert.

In a variant thereof, the insert of the present invention comprises a plurality of first ribs that extend along said first helical path and a plurality of second ribs that extend along said second helical path, said first and second ribs alternating along said longitudinal axis. Advantageously, the opposite ribs on the outer surface of the insert ensure that, when the ribs fill the material that constitutes the body of the bicycle component, there is no mutual sliding between insert and bicycle component that incorporates the insert.

In a further variant, the insert of the present invention comprises a plurality of grooves that extend along said first helical path and a plurality of ribs that extend along said second helical path, said grooves alternating along said longitudinal axis with said ribs. Also in this case, advantageously, the ribs opposite the grooves on the outer surface of the insert ensure that, when the ribs fill the material that constitutes the body of the bicycle component and the grooves are filled by such a material, there is no mutual sliding between insert and bicycle component that incorporates the insert.

Irrespective of the specific embodiment of the insert of the present invention, preferably, the body of the insert comprises a through hole extending along said longitudinal axis.

More preferably, said through hole has a square section and has, at a free end thereof, a widened zone defining an undercut surface. Advantageously, such geometry is suitable for allowing the coupling between an insert incorporated in the body of a pedal crank and an axle of the bottom bracket, such an axle being typically square shaped. In such a case, indeed, the undercut surface is suitable for housing in abutment the widened head of a locking screw that engages in the through hole of the insert and that is intended to engage with the end of the square axle of the bottom bracket.

Preferably, the body of the insert of the present invention is made from metallic material (preferably aluminum alloy) or, alternatively, from composite material comprising a structural fiber (preferably carbon fiber).

In a second aspect thereof, the present invention relates to a bicycle component, comprising at least one insert for the coupling with another bicycle component, wherein said at least one insert is an insert of the type described above.

Advantageously, such a bicycle component, comprising the insert of the present invention, allows all of the advantages mentioned above with respect to such an insert to be achieved.

Preferably, such a bicycle component is a pedal crank.

### DETAILED DESCRIPTION

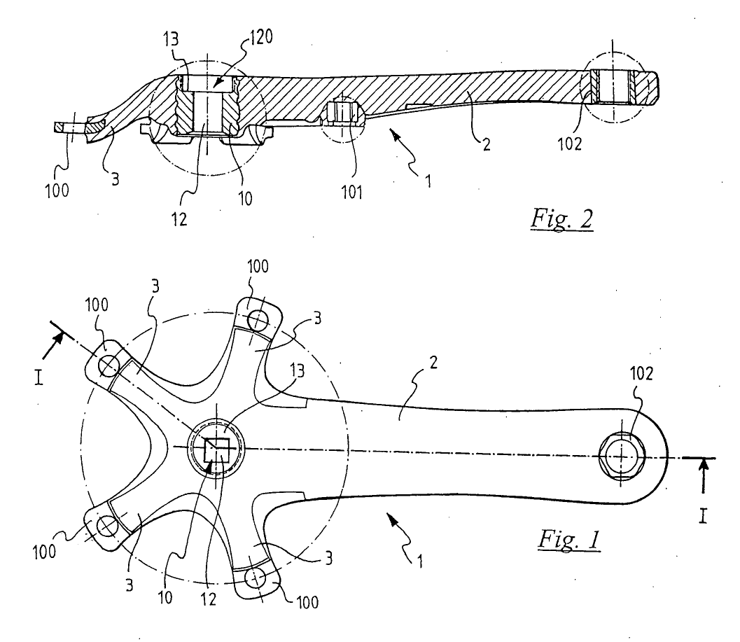

In FIGS. 1 and 2, a bicycle component 1 is, in particular, a spoked right pedal crank that comprises a body 2, preferably made from composite material, in which an axle insert 10 is housed. Said axle insert 10 acts as an interface for the connection of the pedal crank 1 to an axle (not illustrated) of the bottom bracket of the bicycle. The axle insert 10 is an insert in accordance with the present invention and the structural characteristics thereof shall be described in detail in the rest of the present description.

A person of ordinary skill in the art will appreciate that the axle insert 10 can be used in different-shaped pedal cranks, and also in bicycle components other than pedal cranks. Such bicycle components could include a seat post, in which case the insert would be the connection part of the head of the seat-support to the seat tube, or the bracket of the seat-support, in which case the insert would be the attachment interface of the bracket to the seat.

The pedal crank 1 has a certain number of spokes or crankarms 3, four in the case illustrated, for the connection of the pedal crank 1 to the toothed wheels (not illustrated) of the crankset of the bicycle. For such a purpose, each spoke 3 is equipped with a respective spoke insert 100 adapted to act as an interface in the coupling of the spoke 3 with the toothed wheels of the crankset of the bicycle.

The pedal crank 1 also comprises an intermediate crank insert 101 (visible in FIG. 2) embedded in the body 2 of the pedal crank, again for the coupling with the toothed wheels of the crankset of the bicycle, and a pedal insert 102 for the coupling with a pedal (not illustrated) of the bicycle.

The spoke and crank inserts 100 and 101 are preferably arranged equally spaced apart along the same virtual circumference, illustrated with a dotted and dashed line in FIG. 1. In other types of right pedal cranks, the number of spokes can be different and the distribution of the spokes with respect to the longitudinal middle axis of the pedal crank 1 can be such that the connection to the toothed wheels occurs just through the spokes 3 and therefore the intermediate crank insert 101 in the body 2 of the pedal crank is not required.

The inserts 100, 101 and 102 are of a conventional type and therefore are not described here. It is however clear that such inserts can be made in a totally analogous and/or equivalent way to the axle insert 10 of the present invention.

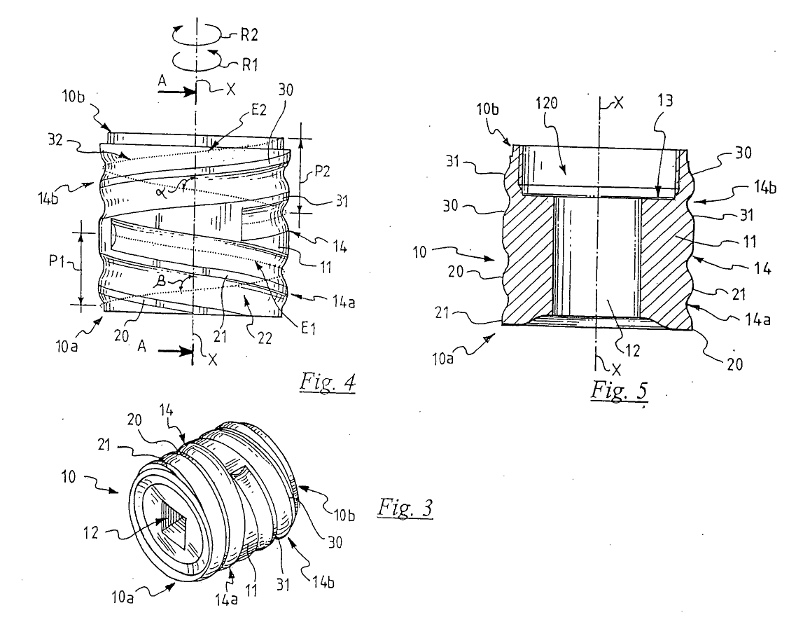

As illustrated in FIGS. 3 to 8, the axle insert 10 comprises a substantially tubular body 11 that has a through hole 12 on its inside for the connection to the central axle of the bottom bracket.

The axle insert 10 extends along a main axis X-X from a proximal end 10a in assembled state, that is on the side of the bottom bracket, to a distal end 10b in assembled state, that is at the opposite side to the bottom bracket.

The through hole 12 has a square section to receive and coupling with the end of the axle (also square in shape) of the bottom bracket. The through hole 12 has, at the distal end 10b of the axle insert 10, a widened annular zone 120 (see for example FIG. 5) with respect to the size of the through hole 12, which makes an undercut surface 13 adapted to receive in abutment the widened head of a locking screw, not shown, which engages in a threaded hole made in the square end of the axle of the bottom bracket.

It is clear that in other embodiments the through hole 12 of the axle insert 10 could have a different shape according to the shape of the end of the central axle.

In accordance with the present invention, the body 11 of the axle insert 10 has an outer surface 14 provided with elements adapted to provide a contrasting response to an attempt of relative rotation movement between axle insert 10 and pedal crank 1, so as to prevent possible mutual movements between axle insert 10 and pedal crank 1 during travel, which would cause a deterioration of the insert-pedal crank coupling.

In particular, such elements are projections or recesses oriented so that at least one of them extends on the outer surface 12 of the axle insert 10 along a direction inclined, with respect to a generatrix of the body 11 parallel to the longitudinal axis X-X, by a first angle a preferably between 0 and 90° and at least another of such projections or recesses extends on the outer surface 12 along a direction inclined, with respect to said generatrix, by a second angle β of between 90° and 180°, such an angle β preferably being supplementary to the aforementioned angle α.

Preferably, such inclined directions are identified by respective helical paths E1, E2 indicated with a broken line in FIG. 4.

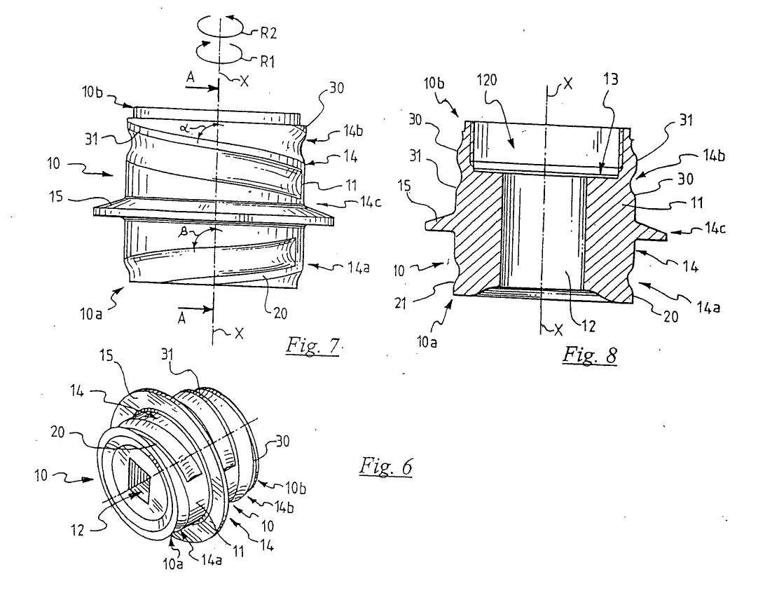

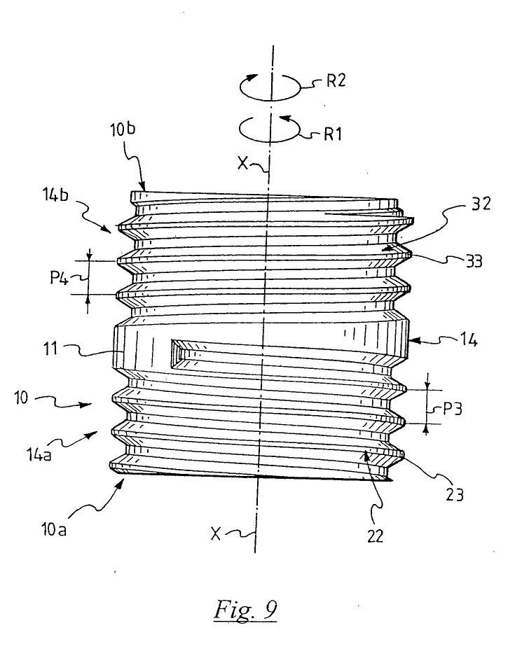

FIGS. 3-5 show a first embodiment of the axle insert 10. A first alternative embodiment is illustrated in FIGS. 6-8. Further alternative embodiments are illustrated in FIGS. 9-12. In these figures, identical structural elements are indicated with the same reference numerals.

With reference to the embodiment of the axle insert 10 illustrated in FIGS. 3-5, the elements adapted to provide a contrasting response to an attempt of relative rotation movement between insert and pedal crank comprise opposite threadings 22, 32 that extend onto the outer surface 14 of the axle insert 10 in two opposite halves 14a, 14b thereof along respective helical paths E1, E2.

In particular, on the outer surface 14 of the insert 1 a proximal portion 14a (the lower portion in the view of FIGS. 4 and 5), which extends on the axle insert 10 for about half of its length along the longitudinal axis X-X, and a distal portion 14b (the upper portion in the view of FIGS. 4 and 5), which extends on the axle insert 10 for the other half of its length along the longitudinal axis X-X are defined.

The proximal portion 14a of the axle insert 10 has a first thread 20 that winds as a helix, starting roughly from the proximal end 10a of the axle insert 10, up to roughly the half-way point of the axle insert 10 in an anti-clockwise direction of rotation R1 (looking at the insert from below, with reference to FIG. 4) with pitch P1. A second thread 21 winds as a helix contiguous to the first thread 20 in the same anti-clockwise direction of rotation R1 and with the same pitch P1 as the first thread 20, also roughly from the proximal end 10a of the axle insert 10 up to roughly the half-way point of the axle insert 10. Such geometry substantially achieves a threading 22 with two threads wherein the threading 22 extends on the outer surface 14 of the axle insert 10 along the helical path E1 with pitch P1 and direction of rotation R1. The two threads 20, 21 are preferably out of phase by 180° in the cross section of the axle insert 10.

In the same way, the distal portion 14b of the axle insert 10 has a first thread 30 that winds as a helix with pitch P2 starting from about the half-way point of the axle insert 10 up to the distal end 10b of the axle insert 10 in a clock-wise direction of rotation R2 (again, looking at the insert from below, with reference to FIG. 4), opposite the clockwise direction of rotation R1 of the threads 20, 21 of the proximal portion 14a. A second thread 31 winds as a helix contiguous to the first thread 30 and with the same pitch P2 and in the same direction of rotation R2 as the latter, also roughly from the half-way point of the axle insert 10 up to the distal end 10b. Such geometry substantially achieves a threading with two threads 32 wherein the threading winds onto the outer surface 14 of the axle insert 10 along the helical path E2 with pitch P2 and direction of rotation R2. The two threads 30, 31 are also preferably out of phase by 180° in the cross section of the axle insert 10.

Preferably, the pitch P2 is selected equal to the pitch P1 but, in different variant embodiments, the values of the pitch P1 and P2 could be chosen to be different to each other.

Obviously, the direction of rotation of the threadings 22, 32 in the proximal portion 14a and distal portion 14b of the outer surface 14 can be the inverse to what is described above.

FIGS. 6 to 8 illustrate an alternative embodiment of the axle insert 10 of the present invention. Such an embodiment differs from the one illustrated in FIGS. 3-5 in that the proximal portion 14a of the outer surface of the axle insert 10 extends on the axle insert 10 for a length less than half its length along the longitudinal axis X-X. Between the proximal portion 14a and the distal portion 14b an intermediate portion 14c comprises an annular fin 15 projecting from the outer surface 14 of the axle insert 10. The fin 15 is therefore in the central zone of the axle insert 10, but displaced along the axis X-X towards the proximal end 10a with respect to its longitudinal middle location. In the illustrated embodiment, the fin 15 widens in the direction from distal to proximal.

The fin 15 increases the contact surface between the axle insert 10 and the body 2 of the pedal crank 1, thus increasing the friction between insert and pedal crank.

In the illustrated embodiment, the proximal portion 14a of the axle insert 10 has a first thread 20 that winds as a helix, starting roughly from the proximal end 10a of the axle insert 10, up to the fin 15 in a clockwise direction of rotation R1 (looking. at the insert from below, with reference to FIG. 7) with pitch P1. A second thread 21, visible only in FIG. 8, winds as a helix contiguous to the first thread 20 in the same clockwise direction of rotation R1 and with the same pitch P1 as the first thread 20, also roughly from the proximal end 10a of the axle insert 10 up to the fin 15. Also in this case a threading with two threads is substantially realized. The two threads 20, 21 are preferably out of phase by 180° in the cross section of the axle insert 10.

In the same way, the distal portion 14b of the axle insert 10 has a first thread 30 that winds as a helix with pitch P2 starting from the fin 15 up to the distal end 10b of the axle insert 10 in a anti-clockwise direction of rotation R2 (again, looking at the insert from below, with reference to FIG. 7), opposite the clockwise direction of rotation R1 of the threads 20, 21 of the proximal portion 14a. A second thread 31 winds as a helix contiguous to the first thread 30 and with the same pitch P2 and in the same direction of rotation R2 as it, also roughly from the fin 15 up to the distal end 10b. Also in this case a threading with two threads is substantially realized. The two threads 30, 31 are also preferably out of phase by 180° in the cross section of the axle insert 10.

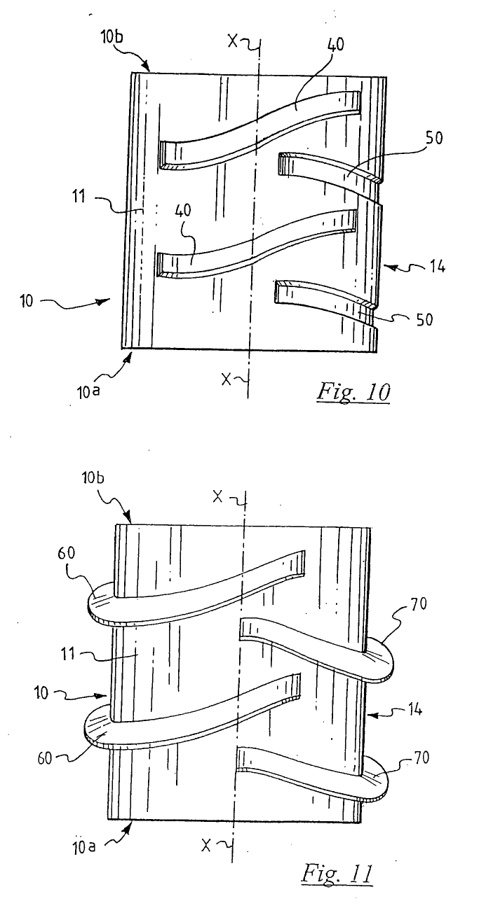

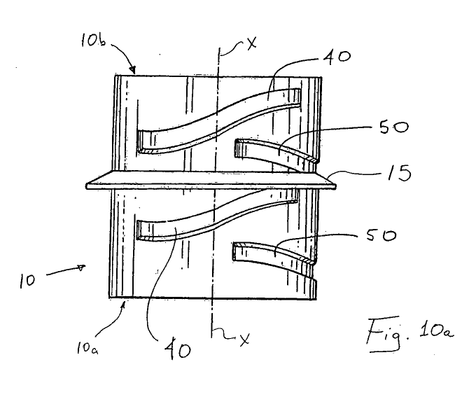

In embodiments that are not illustrated, on the outer surface 14 of the axle insert 10, instead of the aforementioned threadings, grooves or ribs projecting from the outer surface 14 are made that wind as a helix on the body 11 of the axle insert 10 in a way totally consistent with the aforementioned threadings 22 and 32. FIG. 10a shows an embodiment having, in addition to the grooves 40, 50 or ribs 60, a fin 15 of the type illustrated in FIGS. 6-8.

FIG. 9 shows a further embodiment of the axle insert 10 of the present invention that differs from the embodiment illustrated in FIGS. 3-5 only in that each of the threadings 22, 32 consists of a single respective thread 23, 33. In particular, the threading 22 made in the proximal portion 14a is defined by a single thread 23 that winds as a helix on the outer surface 14 roughly from the proximal end 10a of the axle insert 10, up to roughly the half-way point of the axle insert 10 in an anti-clockwise direction of rotation R1 (looking at the insert from below, with reference to FIG. 9) with pitch P3. In the same way, the threading 32 made in the distal portion 14b of the axle insert 10 is defined by a single thread 33 that winds as a helix with pitch P4 starting from about the half-way point of the axle insert 10 up to the distal end 10b of the axle insert 10 in a clockwise direction of rotation R2 (again, looking at the insert from below, with reference to FIG. 9), opposite the anti-clockwise direction of rotation R1 of the thread 23 of the proximal portion 14a.

In the example illustrated in FIG. 9, the pitch P4 is selected equal to the pitch P3 and of a value lower than the value of the pitch P1 and P2 of the embodiments described above. It is obvious that the pitches P3 and P4 can in any case be different to each other, possibly even equal to or greater than the values of the pitch P1 and P2.

Also in this case, embodiments are foreseen in which, in addition to the threadings 22 and 23, a fin 15 of the type illustrated in FIGS. 6-8 is provided.

FIG. 10 shows a further embodiment of the axle insert 10 of the present invention. In such an embodiment, the axle insert 10 comprises, on the outer surface 14 thereof, a plurality of first grooves 40 that extend along a first helical path and a plurality of second grooves 50 that extend along a second helical path opposite the first helical path. The second grooves 50 alternate with the first grooves 40 along the longitudinal axis X-X.

FIG. 11 shows a further embodiment of the axle insert 10 of the present invention. In such an embodiment, the axle insert 10 comprises, on the outer surface 14 thereof, a plurality of first ribs 60 that extend along a first helical path and a plurality of second ribs 70 that extend along a second helical path opposite the first helical path. The second ribs 70 alternate with the first ribs 60 along the longitudinal axis X-X.

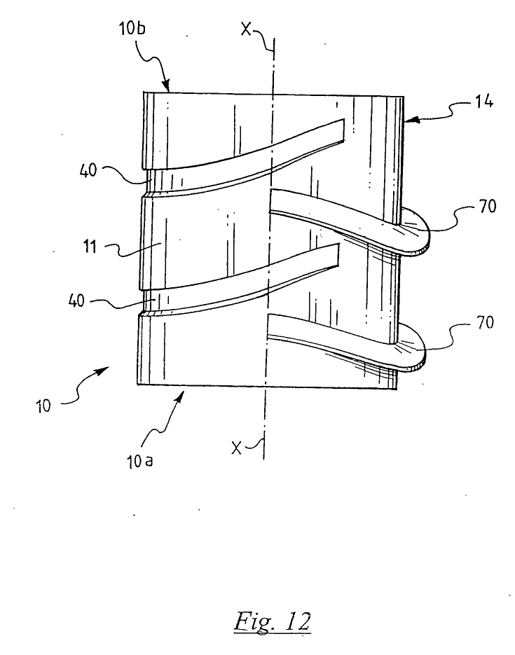

FIG. 12 shows a further embodiment of the axle insert 10 of the present invention. In such an embodiment, the axle insert 10 comprises, on the outer surface 14 thereof, a plurality of grooves 40 that extend along a first helical path and a plurality of ribs 70 that extend along a second helical path opposite the first helical path. The ribs 70 alternate with the grooves 40 along the longitudinal axis X-X.

Although the embodiments described above all refer to inserts 10 having a substantially cylindrical outer surface 14 (apart from the presence of the aforementioned elements adapted to provide a contrasting response to an attempt of relative rotation movement between axle insert 10 and bicycle component that incorporates the insert), what has been stated is also applicable to the case in which the insert has a non-circular cross section (for example elliptical, square, rectangular, etc.), or to the case in which the insert has cross sections of different shape along the longitudinal axis X-X (for example in the case of inserts having a substantially frusto-conical outer surface), or to the case in which the insert has both a non-circular cross section and cross sections of a different shape along the longitudinal axis X-X. In such cases, the aforementioned elements adapted to provide a contrasting response to an attempt of relative rotation movement between axle insert 10 and bicycle component that incorporates the insert extend on the insert along opposite spiral paths, in a substantially analogous way to what has been stated above with reference to the helical paths.

The axle insert 10 is preferably made from metallic material (such as aluminum alloy). In different variant embodiments, the axle insert 10 could be made from another material, for example composite material comprising a structural fiber, preferably carbon fiber, embedded in a matrix of thermoplastic or thermosetting polymeric material. Inserts of this type are described in U.S. Publication No. 2005/0199092 currently assigned to Campagnolo S.r.l., incorporated herein by reference as if fully set forth.

The pedal crank 1 with incorporated axle insert 10 can be manufactured according to any of the methods known to a person of ordinary skill in the art, for example with the co-molding method described in U.S. Publication No. 2003/0037638 currently assigned to Campagnolo S.r.l., incorporated herein by reference as if fully set forth.

What is claimed is:

1. Insert for a bicycle component, comprising a body provided with an outer surface for the coupling with a bicycle component, wherein said outer surface comprises at least one first element that responds to an attempt of relative rotational movement between said bicycle component and said body, wherein said outer surface comprises at least one second element that provides a contrasting response to said attempt of relative rotational movement between said bicycle component and said body.

2. Insert according to claim 1, wherein said at least one first element comprises at least one first groove and said at least one second element comprises at least one second groove.

3. Insert according to claim 1, wherein said at least one first element comprises at least one first rib projecting from said outer surface and said at least one second element comprises at least one second rib projecting from said outer surface.

4. Insert according to claim 1, wherein said at least one first element comprises at least one first groove and said at least one second element comprises at least one first rib projecting from said outer surface.

5. Insert according to claim 1, wherein said body is substantially tubular and extends along a longitudinal axis.

6. Insert according to claim 5, wherein said at least one first element extends on said outer surface for at least one first length inclined, with respect to a generatrix of said body parallel to said longitudinal axis, by at least one first angle (a) of between 0 and 90° and said at least one second element extends on said outer surface for at least one second length inclined, with respect to said generatrix, by at least one second angle of between 90° and 180°.

7. Insert according to claim 6, wherein said first angle and said second angle are supplementary angles.

8. Insert according to claim 6, wherein said at least one first length is at least partially defined along at least one first spiral path that extends on said outer surface in a first direction of rotation and said at least one second length is at least partially defined along at least one second spiral path that extends on said outer surface in a second direction of rotation opposite said first direction of rotation.

9. Insert according to claim 8, wherein said at least one first spiral path is a first helical path that extends on said outer surface with a first pitch in said first direction of rotation and said at least one second spiral path is a second helical path that extends on said outer surface with a second pitch in said second direction of rotation opposite said first direction of rotation.

10. Insert according to claim 9, wherein said second pitch is equal to said first pitch.

11. Insert according to claim 9, wherein said at least one first element comprises at least one first threading that extends on said outer surface along said at least one first helical path and said at least one second element comprises at least one second threading that extends on said outer surface along said at least one second helical path.

12. Insert according to claim 11, wherein said at least one first threading comprises two distinct threads that extend on said outer surface according to said at least one first helical path.

13. Insert according to claim 12, wherein said two threads are out of phase by 180° in a cross section of said body.

14. Insert according to claim 9, wherein said at least one second threading comprises two distinct threads that extend on said outer surface according to said at least one second helical path.

15. Insert according to claim 14, wherein said two threads are out of phase by 80° in a cross section of said body.

16. Insert according to claim 11, wherein said at least one first threading is a single thread.

17. Insert according to claim 11, wherein said at least one second threading is a single thread.

18. Insert according to claim 9, wherein said at least one first element comprises at least one first groove that extends on said outer surface along at least part of said at least one first helical path and said at least one second element comprises at least one second groove that extends on said outer surface along at least part of said at least one second helical path.

19. Insert according to claim 9, wherein said at least one first element comprises at least one first rib that extends on said outer surface along at least part of said at least one first helical path and said at least one second element comprises at least one second rib that extends on said outer surface along at least part of said at least one second helical path.

20. Insert according to claim 9, wherein said outer surface comprises a first portion that extends at least in part on a first half of said body along said longitudinal axis and a second portion that extends at least in part on the other half of said body along said longitudinal axis and wherein said at least one first helical path extends in said first portion and said at least one second helical path extends in said second portion.

21. Insert according to claim 1, comprising at least one fin projecting cantilevered from said outer surface.

22. Insert according to claim 21, wherein said outer surface comprises a first portion that extends at least in part on a first half of said body along said longitudinal axis and a second portion that extends at least in part on the other half of said body along said longitudinal axis and wherein said at least one first helical path extends in said first portion and said at least one second helical path extends in said second portion, wherein said second portion entirely extends on said first half of said body and said second portion extends on the other half of said body for a length less than the length of said half of the body, and wherein between said first and second portions an intermediate portion is defined that comprises said at least one fin.

23. Insert according to claim 21, wherein said at least one fin extends annularly around said body.

24. Insert according to claim 18, comprising a plurality of first grooves that extend along said first helical path and a plurality of second grooves that extend along said second helical path, said first and second grooves alternating along said longitudinal axis.

25. Insert according to claim 19, comprising a plurality of first ribs that extend along said first helical path and a plurality of second ribs that extend along said second helical path, said first and second ribs alternating along said longitudinal axis.

26. Insert according to claim 8, comprising a plurality of grooves that extend along said first helical path and a plurality of ribs that extend along said second helical path, said grooves alternating along said longitudinal axis with said ribs.

27. Insert according to claim 5, wherein said body comprises a through hole extending along said longitudinal axis.

28. Insert according to claim 27, wherein said through hole has a square section and has, at a free end thereof, a widened zone defining an undercut surface.

29. Insert according to claim 1, wherein said body is made from metallic material.

30. Insert according to claim 29, wherein said metallic material is aluminum alloy.

31. Insert according to claim 1, wherein said body is made from composite material comprising a structural fiber.

32. Insert according to claim 31, wherein said structural fiber is carbon fiber.

33. Bicycle component, comprising at least one insert for the coupling with another bicycle component, wherein said at least one insert is an insert according to claim 1.

34. A pedal crank according to claim 33.

35. An insert for a bicycle component comprising a body with an outer surface that couples with a bicycle component, wherein said outer surface comprises at least one first element and at least one second element, each of said first and second elements resisting rotational movement between said bicycle component and said body in substantially opposed directions.

36. An insert for a bicycle component comprising a body with an outer surface that couples with a bicycle component, wherein said outer surface comprises at least one first element and at least one second element, each of said first and second elements located on said outer surface of said body and wrapping helically around said surface in opposite directions.

37. A bicycle component insert having anti-rotational features, the insert comprising;
a body with an exterior surface for coupling with a bicycle component and an inner surface for coupling said bicycle component to a bicycle part; and
said exterior surface has a first element that resists rotational movement in a first direction between said body and said bicycle component and a second element that resists rotational movement between said body and said bicycle component in a second direction different from said first direction.

38. The insert of claim 37 wherein said first and elements are oppositely directed helices.

39. The insert of claim 38 wherein at least one of said oppositely directed helices is not a continuous helix.

40. The insert of claim 38 wherein said oppositely directed helices are not continuous helices.

41. The insert of claim 37 wherein one of said first and second elements defines a maximum exterior dimension for said insert.

42. The insert of claim 37 wherein said first and second elements define a maximum exterior dimension.

43. The insert of claim 37 wherein one of said first and second elements defines a maximum exterior dimension for said insert and the other of said of said first and second elements defines a minimum exterior dimension for said insert.

44. The insert of claim 37 wherein said first and second elements are separated by a portion of said exterior surface.

45. The insert of claim 37 wherein said insert has opposite ends and each of said first and second elements is adjacent to at least one of said ends.

46. The insert of claim 37 wherein at least one of said elements is not continuous.

47. The insert of claim 37 wherein said first and second elements are not continuous.

48. A bicycle component insert having anti-rotational features, the insert comprising;
a body with an exterior surface for coupling with a bicycle component and an inner surface for coupling said bicycle component to a bicycle part;
said exterior surface has a first element that resists rotational movement in a first direction between said body and said bicycle component and a second element that resists rotational movement between said body and said bicycle component in a second direction different from said first direction; and
at least one fin projecting outward from the exterior surface.

49. The insert of claim 48, wherein said at least one fin extends annularly around said body.

50. Insert for a bicycle component, comprising a body provided with an outer surface for the coupling with a bicycle component, wherein said outer surface comprises at least one first element that responds to an attempt of relative rotational movement between said bicycle component and said body, wherein said outer surface comprises at least one second element that provides a contrasting response to said attempt of relative rotational movement between said bicycle component and said body, wherein said body is substantially tubular and extends along a longitudinal axis and wherein said at least one first element extends on said outer surface for at least one first length inclined, with respect to a generatrix of said body parallel to said longitudinal axis, by at least one first angle of between 0 and 90° and said at least one second element extends on said outer surface for at least one second length inclined, with respect to said generatrix, by at least one second angle of between 90° and 180°, wherein said at least one first length is at least partially defined along at least one first spiral path that extends on said outer surface in a first direction of rotation and said at least one second length is at least partially defined along at least one second spiral path that extends on said outer surface in a second direction of rotation opposite said first direction of rotation, wherein said at least one first spiral path is a first helical path that extends on said outer surface with a first pitch in said first direction of rotation and said at least one second spiral path is a second helical path that extends on said outer surface with a second pitch in said second direction of rotation opposite said first direction of rotation, wherein said at least one first element comprises at least one first threading that extends on said outer surface along said at least one first helical path and said at least one second element comprises at least one second threading that extends on said outer surface along said at least one second helical path, wherein said at least one first threading comprises two distinct threads that extend on said outer surface according to said at least one first helical path and said at least one second threading comprises two distinct threads that extend on said outer surface according to said at least one second helical path.
